(19) United States
(12) Patent Application Publication
(10) Pub. No.: US 2013/0166970 A1
(43) Pub. Date: Jun. 27, 2013

(54) BROADCASTING RECEPTION APPARATUS AND METHOD OF CONTROLLING CABLE CARD

(71) Applicant: Samsung Electronics Co., Ltd., Suwon-si (KR)

(72) Inventor: Byeong-Woo JUNG, Yongin-si (KR)

(73) Assignee: SAMSUNG ELECTRONICS CO., LTD., Suwon-si (KR)

(21) Appl. No.: 13/683,803

(22) Filed: Nov. 21, 2012

(30) Foreign Application Priority Data
Dec. 26, 2011 (KR) 10-2011-0142303

(51) Int. Cl. H04N 21/41; G06F 11/07

(52) U.S. Cl. CPC H04N 21/4104; G06F 11/07
USPC 714/57; 725/132

(57) ABSTRACT

A broadcasting reception apparatus and method of controlling a cable card are provided. The broadcasting reception apparatus includes an interface unit configured to mount a cable card, a cable card configured to be mounted in the interface unit and to process broadcasting service information, and a control unit configured to periodically receive a protocol message according to a preset specification from the cable card when the cable card is mounted in the interface unit. The control unit may transmit to the cable card a request signal requesting transmission of the protocol message if the protocol message is not received at a preset first critical time, and initialize the cable card if the protocol message is not received at a second critical time after the request signal is transmitted to the cable card. Therefore, recovery from a failure of the cable card is rapidly performed.

### CROSS-REFERENCE TO RELATED APPLICATION

This application claims priority from Korean Patent Application No. 10-2011-0142303, filed on Dec. 26, 2011, in the Korean Intellectual Property Office, the disclosure of which is incorporated herein in its entirety by reference.

### BACKGROUND

1. Field

Apparatuses and methods consistent with exemplary embodiments relate to a broadcasting reception apparatus and method, and more particularly, to a broadcasting reception apparatus and method capable of controlling a cable card.

2. Description of the Related Art

In general, a broadcasting reception apparatus such as a set-top box receives a broadcasting and provides various additional services related to the broadcasting. For example, the broadcasting reception apparatus provides an additional video on demand (VOD) service. Here, the VOD service is a customized image information service which provides image data requested by a subscriber at a desired time. Therefore, the subscriber enters broadcasting content information to receive the additional service, such as the VOD service, through the broadcasting reception apparatus.

When the broadcasting content information is received, a cable card embedded in the broadcasting reception apparatus sends a request corresponding to the broadcasting content information to a host server in which a plurality of image data are stored. Then, when a broadcasting signal for the broadcasting content requested by the subscriber is received from the host server, the cable card converts the received broadcasting signal into image data of a format displayable by a display apparatus such as a television (TV). Thus, it is possible for the subscriber to watch his/her desired broadcast at a desired time.

However, when a failure occurs in the cable card or is caused by the cable card, such as a hangup failure or a suspend failure, the corresponding cable card continuously transmits the information related to the broadcasting service to the host server. When such a failure occurs, in which a specific cable card continuously transmits the information related to the broadcasting service to the host server, the specific cable card occupies the entire cable network so that it is impossible for the host server to provide a bidirectional service to a plurality of other cable network subscribers.

To solve the problem, in the related art, a host server manager directly visits a place where a failed broadcasting reception apparatus is installed and performs a recovery operation for the failed broadcasting reception apparatus to normally operate. Performing the recovery operation by a direct visit of the host server manager in a situation as described above, requires an increased amount of time to provide a smooth bidirectional service to the plurality of cable subscribers and thus the maintenance costs are increased.

### SUMMARY

One or more exemplary embodiments may overcome the above disadvantages and other disadvantages not described above. However, it is understood that one or more exemplary embodiments are not required to overcome the disadvantages described above, and may not overcome any of the problems described above.

One or more exemplary embodiments provide a broadcasting reception apparatus and a method of recovering a failure of a cable card which is mounted in the broadcasting reception apparatus.

One or more exemplary embodiments also provide a broadcasting reception apparatus and a method of providing a smoothly bidirectional service to cable network subscribers.

According to an aspect of an exemplary embodiment, there is provided a broadcasting reception apparatus including: an interface unit and a cable card configured to be mounted in the interface unit and to process broadcasting service information; and a control unit configured to periodically receive a protocol message from the cable card according to a preset specification when the cable card is mounted in the interface unit. The control unit may transmit a request signal to the cable card requesting the cable card to transmit the protocol message when the protocol message is not received at a preset first critical time, and the control unit initializes the cable card when the protocol message is not received at a second critical time after the request signal is transmitted to the cable card.

The cable card may store certification information which is required to receive a broadcasting service. The control unit may perform certification with a host server using the certification information stored in the cable card and may periodically check whether a protocol message is received at a point in time when the certification is completed.

The protocol message may include an application protocol data unit (APDU) message.

The apparatus may further include an output unit configured to output an error message. The control unit may repeatedly perform an initialization operation for the cable card a preset number of times when the protocol message is not received even after the cable card is initialized, and output an error message when the protocol message is not received after the cable card is repeatedly initialized.

The control unit may initialize the broadcasting reception apparatus when the protocol message is not received after the cable card is initialized.

According to another aspect of the exemplary embodiment, a method of controlling a cable card of a broadcasting reception apparatus is provided in which the cable card is mounted and configured to process broadcasting service information. The method may include periodically receiving a protocol message from the cable card according to a preset specification; transmitting a request signal to the cable card requesting transmission of the protocol message if the protocol message is not received at a preset first critical time; and initializing the cable card if the protocol message is not received at a preset second critical time after the request signal is transmitted to the cable card.

The receiving may include performing certification with a host server using certification information stored in the cable card; and checking whether the protocol message is received from the cable card at the first critical time at a point in time when the certification is completed.

The method may further include repeatedly performing an initialization operation for the cable card a preset number of times when the protocol message is not received after the cable card is initialized, and outputting an error message when the protocol message is not received after the cable card is repeatedly initialized.

The method may further include initializing the broadcasting reception apparatus if the protocol message is not received if the cable card is initialized.

The protocol message may be an APDU message.

According to another aspect of the exemplary embodiment, a non-transitory computer-readable recording medium is provided recording a program to execute a method of controlling a cable card of a broadcasting reception apparatus. The method of controlling the cable card may include periodically receiving a protocol message from the cable card connected to the broadcasting reception apparatus according to a preset specification; transmitting a request signal to the cable card requesting transmission of the protocol message if the protocol message is not received at a preset first critical time; and initializing the cable card if the protocol message is not received at a preset second critical time after the request signal is transmitted to the cable card.

The receiving may include performing certification with a host server using certification information stored in the cable card; and checking whether the protocol message is received from the cable card at the first critical time at a point in time when the certification is completed.

The protocol message may be an APDU message.

According to the above-described various exemplary embodiments, when a broadcasting reception apparatus checks an operation state of a cable card mounted therein and determines the cable card as having a failure, the broadcasting reception apparatus autonomously performs a reset operation to cause an operation of the cable card to be initialized so that recovery for failure of the cable card may be rapidly made. Therefore, it is possible to provide a smooth bidirectional service to cable network subscribers.

Additional aspects and advantages of the exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIG. 1 is a block diagram illustrating a general broadcasting reception system which provides a broadcasting service through a cable network according to an exemplary embodiment;

FIG. 2 is a block diagram illustrating a broadcasting reception apparatus according to an exemplary embodiment;

FIG. 3 is a flowchart of a method of controlling an operation of a cable card in a broadcasting reception apparatus according to an exemplary embodiment; and

FIG. 4 is a flowchart of a process of determining an operation state of a cable card initialized in a broadcasting reception apparatus according to an exemplary embodiment.

### DETAILED DESCRIPTION OF EXEMPLARY EMBODIMENTS

Hereinafter, exemplary embodiments will be described in more detail with reference to the accompanying drawings, in which exemplary embodiments are shown.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

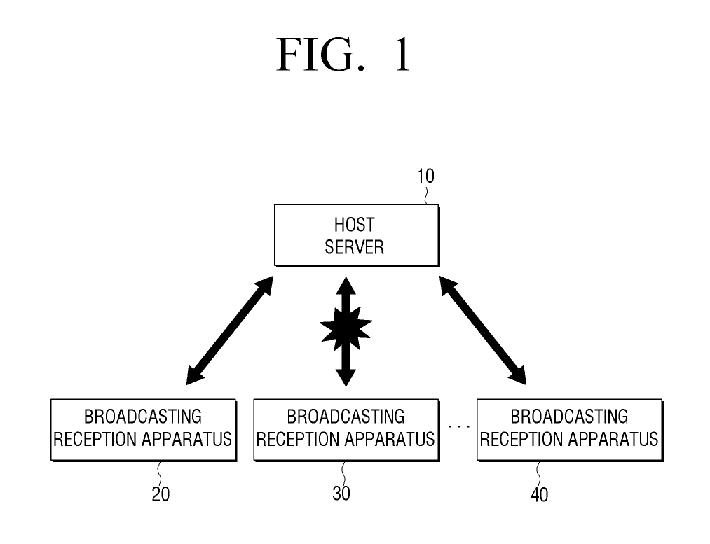

FIG. 1 is a block diagram of a general broadcasting reception system which provides a broadcasting service through a cable network according to an exemplary embodiment.

Referring to FIG. 1, a broadcasting reception system which provides a broadcasting service such as VOD includes a host server 10 and a plurality of broadcasting reception apparatuses 20 to 40. The host server 10 stores a plurality of broadcasting contents related to a broadcasting service and each of the broadcasting reception apparatuses 20 to 40 is an apparatus which converts a broadcasting signal related to the broadcasting content received from the host server 10 into image data of a displayable format and provides the converted image data to a display apparatus. Specifically, the plurality of broadcasting reception apparatuses 20 to 40 are connected to the host server 10 via a cable network and receive broadcasting signals related to broadcasting contents requested by subscribers from the host server 10 through the cable network. Then, the plurality of broadcasting reception apparatuses 20 to 40 convert the broadcasting signals received from the host server 10 into image data of a displayable format. As a result, the subscribers may watch the image data requested thereby any time through the display apparatuses connected to the broadcasting reception apparatuses 20 to 40, respectively.

The plurality of broadcasting reception apparatuses 20 to 40, which connect to the host server 10 through the cable network and receive broadcasting services. In particular, the broadcasting reception apparatuses 20 to 40 request broadcasting contents requested by the subscribers, i.e., they send requests to the host server through the cable cards, receive broadcasting signals corresponding to the broadcasting contents, and convert the received broadcasting signals into image data of a displayable format. When the cable cards transmit broadcasting service request information corresponding to the request of the subscribers to the server 10, a failure such as a hangup or a suspend may occur. As a result, the cable cards may continuously transmit the broadcasting service request information. For example, as shown in FIG. 1, a cable card, which is mounted in the broadcasting reception apparatus 30 among the plurality of broadcasting reception apparatuses 20 to 40, failed and continuously transmits the broadcasting service request information to the host server 10. In this case, the broadcasting reception apparatus 30 may occupy the entire cable network and thus the host service may be unable to smoothly provide broadcasting services to the broadcasting reception apparatuses 20 and 40.

When the cable card of the broadcasting reception apparatus 30 failed as described above, the manager related to the host server 10 may move to a location in which the broadcasting reception apparatus 30 is installed and may perform a recovery operation for the failed broadcasting reception apparatus 30. As described above, in the broadcasting reception system of the related art, for example, when at least one of the plurality of broadcasting reception apparatuses 20 to 40 failed, the manger of the host server 10 needs to perform a recovery operation which requires time. In other words, the amount of time necessary to provide a smooth bidirectional service to the plurality of cable network subscribers in the related art broadcasting system is considerably high.

Hereinafter, an operation of recovering a failure of a cable card in the broadcasting reception apparatus according to an exemplary embodiment will be described in detail.

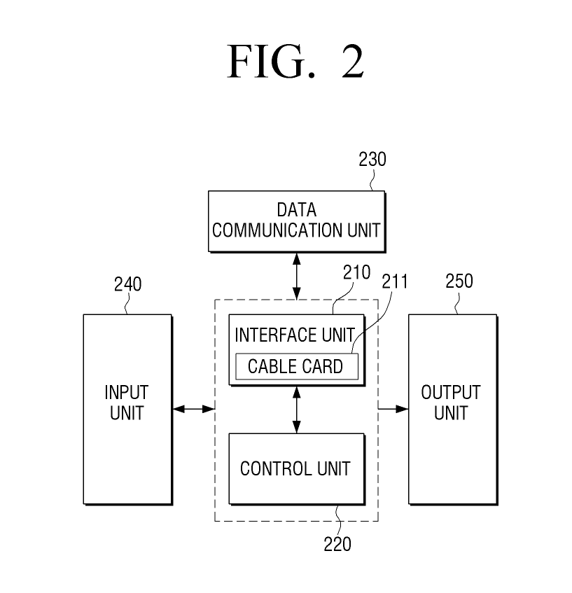

FIG. 2 is a block diagram illustrating a broadcasting reception apparatus according to an exemplary embodiment.

As shown in FIG. 2, the broadcasting reception apparatus includes an interface unit 210 and a control unit 220. A cable card 211, which is configured to process broadcasting service information, is mounted in the interface unit 210. The control unit 220 periodically receives a protocol message according to a preset communication specification from the cable card 211 through the interface unit 210. The cable card 211 stores certification information including subscriber information and identification information for receiving the broadcasting service information.

When the cable card 211 is mounted in the interface unit 210, the cable card 211 transmits pre-stored certification information including the subscriber information and identification information to the host server 10 through a data communication unit 230. Then, the host server 10 performs certification to provide a broadcasting service using the certification information received from the cable card 211.

When the certification between the host server 10 and the cable card 211 is completed, the cable card 211 may transmit/receive information related to the broadcasting service to/from the host server 10 through the data communication unit 230. According to an exemplary embodiment, a subscriber may request a broadcast content that the subscriber wants to watch. The information for the broadcasting content may be input through an input unit 240. If information for the broadcasting content requested by the subscriber is input through the input unit 240, the cable card 211 transmits request information for the broadcasting content to the host server 10 through the data communication unit 230. Then, the cable card 211 receives a broadcasting signal for the broadcasting content from the host server 10, converts the received broadcasting signal into image data of a displayable format, and outputs the converted image data. The subscriber may then watch an image related to the broadcasting content requested thereby.

When the certification with the host server 10 is completed, the cable card 211 periodically transmits a protocol message according to a preset communication specification to the control unit 220 through the interface unit 210. The protocol message according to the communication specification may be an APDU protocol message. The APDU message includes application protocol control information and application layer subscriber information in units of data. The units of data are transmitted between or received from equal application entities in application layers.

The control unit 220 may perform the following operation to recognize whether the protocol message is periodically received from the cable card 211 and thus determines whether a failure occurred in the cable card 211.

Specifically, the control unit 220 checks whether the protocol message according to the communication specification is periodically received from the cable card 211 through the interface unit 210 at a preset first critical time. As a checking result, if the protocol message is received at the preset first critical time, the control unit 220 determines that the cable card 211 operates normally. Meanwhile, as a checking result, if the protocol message is not received at the preset first critical time from the cable card 211, the control unit 220 transmits a request signal, requesting transmission of the protocol message, to the cable card 211.

Then, the control unit 220 checks whether the protocol message is received at a preset second critical time from the cable card 211 which transmits the request signal requesting the transmission of the protocol message. As a result, if the protocol signal is received from the cable card 211 at the preset second critical time, the control unit 220 determines that an operation of the cable card 211 is normal. Thereafter, the control unit 220 checks whether the protocol message is received from the cable card 211 at the first critical time.

As a checking result, if the protocol message is not received at the preset second critical time from the cable card 211, the control unit 220 determines that a failure occurred in the cable card 211. However, a method of determining the failure of the cable card 211 is not limited to the above-described determination method. After the request signal for requesting transmission of a protocol message is first transmitted, if the protocol message is not received at the preset second critical time, the control unit 220 may transmit the request signal for the transmission of the protocol message to the cable card 211 again. That is, the control unit 220 may transmit the request signal requesting the transmission of the protocol message to the cable card 211 again a preset number of times and may determine that the cable card 211 failed if the protocol message is not received at the second critical time.

As described above, if the protocol message is not received from the cable card 211 at the second critical time, the control unit 220 performs a reset operation to allow the cable card 211 to be initialized. Then, the control unit 220 checks whether the protocol message is received from the initialized cable card 211 at the preset first critical time or at the preset second critical time. As a checking result, if the protocol message is not received from the initialized cable card 211, the control unit 220 repeatedly performs the reset operation for initializing the cable card 211 a preset number of times. Then, the control unit 22 controls the output unit 250 configured to output an error message to output an error message for notifying the subscriber that an error of the cable card 211 occurred.

As described above, by outputting the error message to the subscriber through the output unit 250, the subscriber determines that a failure occurred in the broadcasting reception apparatus including the cable card 211 and requests failure recovery from the manager related to the host server 10. The manager related to the host server 10 may rapidly recover the failed broadcasting reception apparatus so that it is possible to minimize inconvenience in using the broadcasting service by other cable network subscribers.

In another exemplary embodiment, the control unit 220 initializes the cable card 211 and then performs a reset operation to allow an operation of the broadcasting reception apparatus to be initialized if the protocol message is not received from the initialized cable card 211 at the preset second critical time. If the protocol message is not received at the preset second critical time from the initialized cable card 211, the control unit 220 may determine that a failure in another component of the broadcasting reception apparatus occurred and may initialize an entire operation of the broadcasting reception apparatus. Thus, the broadcasting reception apparatus according to this exemplary embodiment may perform recovery of a failure of the cable card 211 as well as of a failure of the entire operation thereof.

The operation of each of the components of the broadcasting reception apparatus according to the exemplary embodiment has been described above in detail. Now, a method of controlling an operation of the cable card, which is mounted in the broadcasting reception apparatus, will be described in detail.

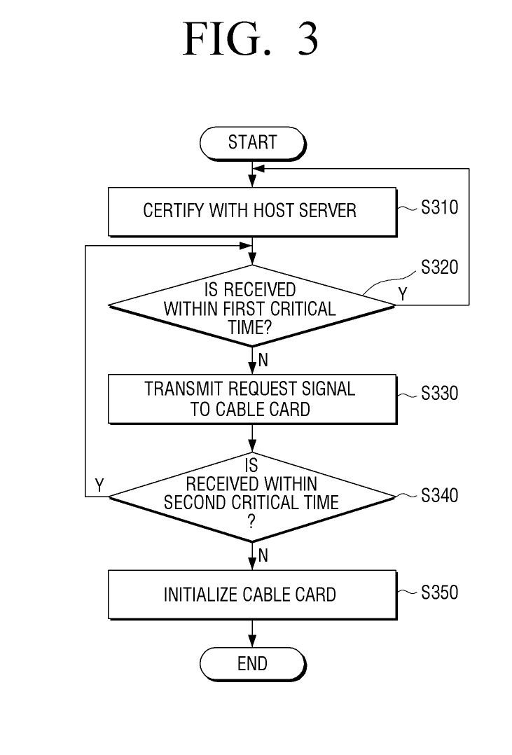

FIG. 3 is a flowchart of a method of controlling an operation of a cable card in a broadcasting reception apparatus according to an exemplary embodiment.

As shown in FIG. 3, a broadcasting reception apparatus periodically receives a protocol message according to a preset communication specification from a cable card. Specifically, the broadcasting reception apparatus performs certification with a host server using certification information stored in the cable card (S310). The certification information is information including subscriber information and identification information exchanged to receiving broadcasting service information from the host server. When the cable card is mounded in the broadcasting reception apparatus, the cable card transmits the pre-stored certification information to the host server. Then, the host server performs certification to provide a broadcasting service. If the certification to provide the broadcasting service from the host server is completed, the broadcasting reception apparatus checks whether the protocol message according to the communication specification is received from the cable card at a preset first critical time (S320).

The protocol message according to the communication specification may be an APDU message. The APDU message includes application protocol control information and application layer subscriber information in units of data. The units of data are transmitted between or received from equal application entities in application layers. The broadcasting reception apparatus checks whether the protocol message is periodically received at the preset first critical time from the cable card.

As a checking result, if the protocol message is received at the preset first critical time, the broadcasting reception apparatus determines that the cable card operates normally. Then, the broadcasting reception apparatus continuously checks whether the protocol message is received from the cable card at the preset first critical time. If the protocol message is not received at the preset first critical time, as a checking result, the broadcasting reception apparatus determines that the cable card operates abnormally. Then, the broadcasting reception apparatus transmits a request signal to the cable card requesting transmission of the protocol message (S330). Next, the broadcasting reception apparatus checks whether the protocol message is received from the cable card at a preset second critical time which transmits the request signal requesting the transmission of the protocol message (S340).

If the protocol message is received at the preset second critical time, the broadcasting reception apparatus determines that the cable card operates normally, and returns to operation S320 to check whether the protocol message is received from the cable card at the first critical time. If the protocol message is not received at the preset second critical time, as a checking result, the broadcasting reception apparatus determines that a failure occurred in the cable card. However, the determination of a failure of the cable card is not limited to the above-described determination method. If the protocol message is not received at the preset second critical time after the request signal requesting the transmission of the protocol message is first transmitted, the broadcasting reception apparatus may transmit the request signal to the cable card again a preset number of times requesting the transmission of the protocol message.

If the protocol message is not received at the preset second critical time after the request signal requesting the transmission of the protocol message is transmitted at least one time or more, the broadcasting reception apparatus may perform a reset operation to allow the cable card to be initialized (S350). As described above, the broadcasting reception apparatus according to the exemplary embodiment autonomously determines whether an operation of the cable card failed in order to re-initialize the operation of the cable card so that failure of the cable card may be recovered as soon as possible without any action of the subscriber or the manager in charge of the host server.

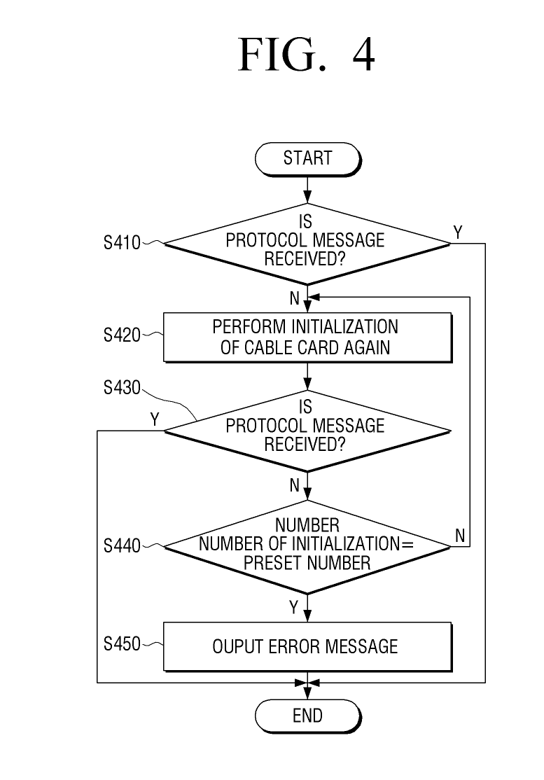

As shown in FIG. 4, after the broadcasting reception apparatus initializes the cable card, the broadcasting reception apparatus may determine whether the initialized cable card operates normally.

FIG. 4 is a flowchart of a process of determining an operation stage of an initialized cable card in a broadcasting reception apparatus according to an exemplary embodiment.

As shown in FIG. 4, after a broadcasting reception apparatus initializes the cable card, the broadcasting reception apparatus may check whether a protocol message is received from the cable card at a preset first critical time or at a preset second critical time (S410). If the protocol message is not received from the initialized cable card at the preset first critical time or at the preset second critical time, the broadcasting reception apparatus performs a reset operation to initialize the cable card again (S420). Then, the broadcasting reception apparatus checks whether the protocol message is received from the cable card and performs the reset operation for initialization of the cable card a preset number of times if the protocol message is not received (S430, S440). After the broadcasting reception apparatus performs the reset operation a preset number of times to initialize the cable card, the broadcasting reception apparatus outputs an error message which includes information about the failure which occured in the cable card (S450).

As described above, the broadcasting reception apparatus outputs the error message on a screen corresponding to the fact that the protocol message is not received from the initialized cable card and thus the subscriber determines that a failure occurred in the broadcasting reception apparatus including the cable card so that the subscriber may request failure recovery to be performed by a manager responsible for the host server. As a result, the host server manager may rapidly recover the failed broadcasting reception apparatus to minimize inconvenience in the use of the broadcasting service by the other cable network subscribers.

In another exemplary embodiment, if the reset operation to initialize the cable card is performed repeatedly a preset number of times in step S440, the broadcasting reception apparatus may determine that another component failed and initializes the operation thereof. The broadcasting reception apparatus according to the exemplary embodiment may perform recovery from a failure of the cable card mounted therein as well as recovery from a failure of the entire operation thereof.

The broadcasting reception method according to the above-described various exemplary embodiments may be recorded on various types of non-transitory computer-readable recording media and may be implemented by a program code to be executed by a CPU provided in various kinds of electronic apparatuses.

Specifically, the program code for executing the above-described method may be stored in various types of non-transitory computer-readable recording media readable by a terminal such as a random access memory (RAM), a flash memory, a read only memory (ROM), an erasable programmable ROM (EPROM), an electronically erasable and programmable ROM (EEPROM), a register, a hard disc, a removable disc, a memory card, a USB memory, a compact disc ROM (CD-ROM).

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A broadcasting reception apparatus comprising:
an interface unit configured to mount a cable card;
a cable card configured to be mounted in the interface unit and to process broadcasting service information; and
a control unit configured to periodically receive a protocol message according to a preset specification from the cable card when the cable card is mounted in the interface unit,
wherein the control unit
transmits to the cable card a request signal requesting transmission of the protocol message if the protocol message is not received at a preset first critical time, and
initializes the cable card if the protocol message is not received at a second critical time after the request signal is transmitted to the cable card.

2. The apparatus as claimed in claim 1, wherein the cable card stores certification information required to receive a broadcasting service, and
wherein the control unit performs certification with a host server using the certification information stored in the cable card and periodically checks whether the protocol message is received at a point in time when the certification is completed.

3. The apparatus as claimed in claim 2, wherein the protocol message includes an application protocol data unit message.

4. The apparatus as claimed in claim 2, further comprising an output unit configured to output an error message,
wherein the control unit repeatedly performs an initialization operation for the cable card a preset number of times if the protocol message is not received even after the cable card is initialized, and outputs an error message if the protocol message is not received after the cable card is repeatedly initialized.

5. The apparatus as claimed in claim 2, wherein the control unit initializes the broadcasting reception apparatus if the protocol message is not received after the cable card is initialized.

6. A method of controlling a cable card of a broadcasting reception apparatus in which the cable card is mounted and configured to process broadcasting service information, the method comprising:
periodically receiving from the cable card a protocol message according to a preset specification;
transmitting to the cable card a request signal requesting transmission of the protocol message if the protocol message is not received at a preset first critical time; and
initializing the cable card if the protocol message is not received at a preset second critical time after the request signal is transmitted to the cable card.

7. The method as claimed in claim 6, wherein the periodically receiving comprises:
performing certification with a host server using certification information stored in the cable card; and
checking whether the protocol message is received from the cable card at the first critical time at a point in time when the certification is completed.

8. The method as claimed in claim 6, further comprising:
repeatedly performing an initialization operation for the cable card a preset number of times if the protocol message is not received after the cable card is initialized; and
outputting an error message if the protocol message is not received after the cable card is repeatedly initialized.

9. The method as claimed in claim 8, further comprising initializing the broadcasting reception apparatus if the protocol message is not received when the cable card is initialized.

10. The method as claimed in claim 6, wherein the protocol message is an application protocol data unit message.

11. A non-transitory computer-readable recording medium recording a program to execute a method of controlling a cable card of a broadcasting reception apparatus in which the cable card is mounted and configured to process broadcasting information, the method comprising:
periodically receiving from the cable card a protocol message according to a preset specification;
transmitting to the cable card a request signal requesting transmission of the protocol message if the protocol message is not received at a preset first critical time; and
initializing the cable card if the protocol message is not received at a preset second critical time after the request signal is transmitted to the cable card.

12. The method as claimed in claim 11, wherein the receiving includes:
performing certification with a host server using certification information stored in the cable card; and
checking whether the protocol message is received from the cable card at the first critical time at a point in time when the certification is completed.

13. The method as claimed in claim 11, wherein the protocol message is an application protocol data unit message.

14. A broadcasting reception system comprising:
a host server connected to a cable network;
at least one broadcasting reception apparatus connected to the host via the cable network;
wherein the at least one broadcasting reception apparatus comprises:
an interface unit configured to mount a cable card;
a cable card configured to be mounted in the interface unit and to process broadcasting service information; and
a control unit configured to periodically receive a protocol message according to a preset specification from the cable card when the cable card is mounted in the interface unit,
wherein the control unit
transmits to the cable card a request signal requesting transmission of the protocol message if the protocol message is not received at a preset first critical time, and
initializes the cable card if the protocol message is not received at a second critical time after the request signal is transmitted to the cable card.

15. The broadcasting reception system as claimed in claim 14, wherein the cable card stores certification information required to receive a broadcasting service, and
wherein the control unit performs certification with the host server using the certification information stored in the cable card and periodically checks whether the protocol message is received at a point in time when the certification is completed.

16. The broadcasting reception system as claimed in claim 14, wherein the protocol message includes an application protocol data unit message.

17. The broadcasting reception system as claimed in claim 14, wherein the control unit initializes the at least one broadcasting reception apparatus if the protocol message is not received after the cable card is initialized.

18. A cable card comprising:
a memory configured to store certification information required to receive a broadcasting service by a broadcasting reception apparatus in which the cable card is mounted,
wherein the cable card is configured to receive from a control unit of the broadcasting reception apparatus a request signal requesting transmission of a protocol message and to transmit to the control unit of the broadcasting reception apparatus the protocol message according to a preset specification when the cable card is mounted in the interface unit.

19. The cable card as claimed in claim 18, wherein the protocol message is an application protocol data unit message.
